(19) United States
(12) Patent Application Publication
(10) Pub. No.: US 2018/0054534 A1
(43) Pub. Date: Feb. 22, 2018

(54) SYSTEM AND METHOD FOR BIOMETRIC-BASED DEVICE HANDEDNESS ACCOMMODATION

(71) Applicants: Kabushiki Kaisha Toshiba, Minato-ku (JP); Toshiba TEC Kabushiki Kaisha, Shinagawa-ku (JP)

(72) Inventors: Jia Zhang, Irvine, CA (US); William Su, Riverside, CA (US)

(21) Appl. No.: 15/241,398

(22) Filed: Aug. 19, 2016

(51) Int. Cl. H04N 1/00; G06K 9/00; G06F 3/0488; H04N 1/44

(52) U.S. Cl. CPC H04N 1/00514; G06K 9/00604; G06K 9/00013; H04N 2201/0094; G06F 3/04886; H04N 1/442; H04N 1/00506; H04N 1/00392

(57) ABSTRACT

A system and method for biometric adaptation of user interfaces includes a touch sensitive display with a biometric sensor configured to receive biometric input from an associated user. A memory stores handedness characteristic data and data corresponding to each of plurality of left handed and right handed control screen patterns for the display. A processor sets handedness of the user in accordance with received biometric input and handedness characteristic and generates a selected control screen pattern from the left handed and right handed control screen patterns on the display in accordance with a set handedness of the user.

### TECHNICAL FIELD

This application relates generally to user interfaces that are adaptable to physical characteristics of users. The application relates more particularly to adjusting a touchscreen user interface for document processing devices in accordance with user handedness.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Given the expense in obtaining and maintain MFPs, devices are frequently shared or monitored by users or technicians via a data network. MFPs, while moveable, are generally maintained in a fixed location. Users may send document processing jobs, such as a print request, to one or more networked devices. In a typical shared device setting, one or more workstations are connected via a network. When a user wants to print a document, an electronic copy of that document is sent to a document processing device via the network. The user may select a particular device when several are available. The user then walks to the selected device and picks up their job or waits for the printed document to be output. A user may need to login or enter credentials before they can complete a print operation or use other MFP features.

When a user approaches an MFP device, logging in if necessary, machine interaction is via a user interface. More recently MFP user interfaces include touchscreens. Touchscreens are advantageous insofar as they can be used to display many different device function controls.

### SUMMARY

In accordance with an example embodiment of the subject application, a system and method for biometric adaptation of user interfaces includes a touch sensitive display with a biometric sensor configured to receive biometric input from an associated user. A memory stores handedness characteristic data and data corresponding to each of plurality of left handed and right handed control screen patterns for the display. A processor sets handedness of the user in accordance with received biometric input and handedness characteristic and generates a selected control screen pattern from the left handed and right handed control screen patterns on the display in accordance with a set handedness of the user.

### BRIEF DESCRIPTION OF THE DRAWINGS

Various embodiments will become better understood with regard to the following description, appended claims and accompanying drawings wherein:

FIG. 1 an example embodiment of a document processing environment;

FIG. 2 is an example embodiment of a document rendering system;

FIG. 3 is an example embodiment of a digital device;

FIG. 4 is an example embodiment of a handedness adaptive user interface;

FIG. 5 is an example embodiment of a first handedness specific screen;

FIG. 6 is an example embodiment of a second handedness specific screen;

FIG. 7 is an example embodiment of a captured fingerprint; and

FIG. 8 is an example flowchart of a system with handedness selection.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

MFP user interfaces provide for direct interaction between users and devices for display of information and generation of various soft controls formed by displaying touch sensitive screen areas. By way of example, a touchscreen may list names of several stored electronic documents, and a user can select one by touching the name of a desired document. A touchscreen may also be programmed to display images that appear like more traditional controls, like push button switches that are activated when screen area encompassed by the image is touched or pressed. Touchscreen interfaces may include slider bars to scroll through lists, or may present images or image portions to be repositioned by dragging or dropping motions. Multi-touch touchscreens allow for interaction such as use of a pinching motion on an image to resize or crop the image. Touchscreens may generate virtual keyboards for data entry, or generate an input box wherein a user can enter handwritten information, such as via a finger or stylus.

The many possible uses for touchscreens can result in complicated interaction sequences between a user and the device. Increasingly capable MFPs result in more options, input and selections from users. This coupled with improving quality and size of displays with shrinking cost trends toward use of bigger and bigger displays.

In an example interaction, a user approaches an MFP device. An associated interface includes a touchscreen that provides a prompt wherein the user must login to the MFP device to access its features, such as by entering a username and password via a virtual keyboard. The user wishes to complete a copy operation, and places an original document in the input tray. The user is prompted for selections relative to a number of desired copies, collating, stapling, hole punching, paper type, front and back printing and combining multiple pages onto one output sheet. These options are presented in the same fashion for all users. However, certain users may be at a disadvantage relative to ease of use of the user interface due to physiological differences.

One easily recognized physiological difference between humans is handedness. Roughly 90% of humans are dextromanual, or possess a dominant right hand. Conversely, roughly 10% of humans are sinistromanual, or possess a dominant left hand. There are pronounced different needs between dextromanual and sinistromanual people. While left handed individuals may be able to use tools or devices designed for the majority of right handed users, some items can be difficult or impossible for left handed users to readily adapt to them. Even if they do, they are frequently at a comfort or efficiency disadvantage relative to right handed users. This leads to products such as left handed scissors, left handed baseball gloves, left handed golf clubs, and the like.

An MFP typically generates a consistent user interface for all users. Often times this can result in a touchscreen that is more difficult for left handed users. By way of example, selection buttons may be placed along a right hand side of a touchscreen. While this is a comfortable placement for most right handed users, a left handed user is required to traverse the touchscreen, left to right, to reach the buttons. This can be particularly difficult with larger and larger touchscreen displays. Also, while reaching, the user's hand is obfuscating all or some of the touchscreen display. Similarly, a signature box generated on the touchscreen may be convenient for right handed users when in a bottom-right area of the touchscreen. However, with this orientation, it may require contortions by a left handed user to be able to reach across their body to enter their signature into a box so placed. Many other device interaction features can be improved when reworked in consideration of left handed users.

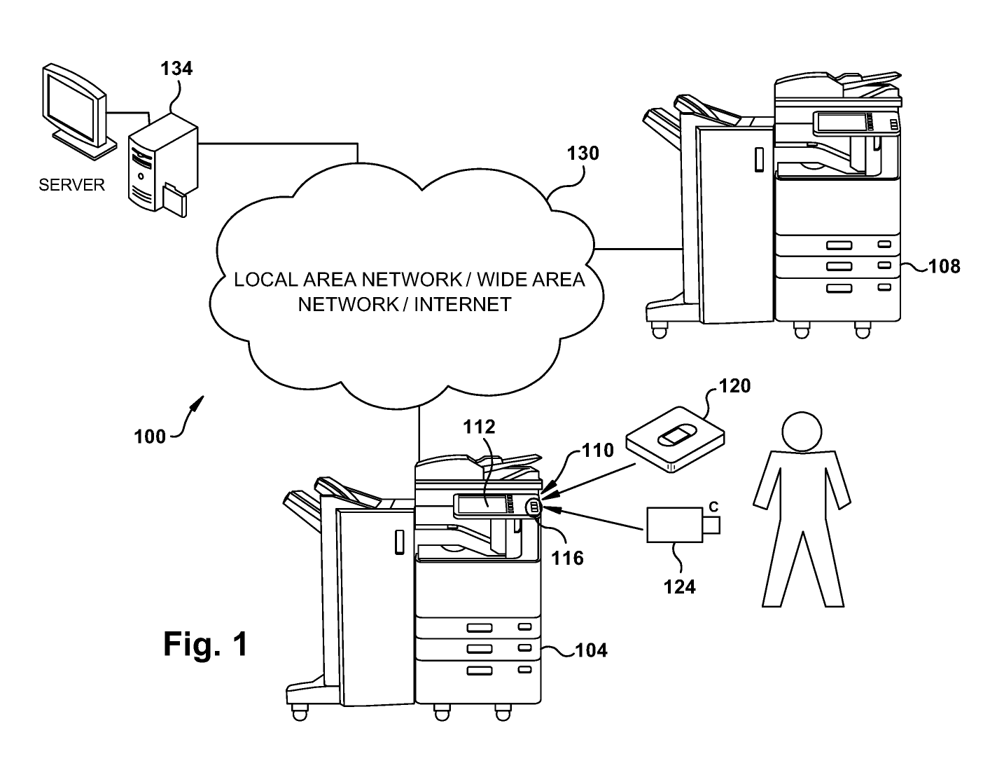

In accordance with the subject application, FIG. 1 illustrates an example embodiment of a document processing environment 100, such as may be found in an office or corporate environment. Included are one or more MFPs, illustrated by MFP 104 and MFP 108. Using MFP 104 as an example, included is a user interface 110. User interface 110 includes touchscreen 112, and may include mechanical switches or selectors such as selection switches 116. User interface 110 can be supplemented with biometric input capabilities. Biometric input enables a device to ascertain a physical characteristic of a user. Biometrics include fingerprints, facial characteristics, height, weight, skin tone, retinal characteristics or the like. Fingerprint input is suitably accomplished via fingerprint reader 120. A fingerprint reader 120 is suitably a dedicated input module. Alternatively, a fingerprint reader 120 may be integrated into a high resolution image capture device, such as camera 124. Fingerprint input may also be accomplished directly on a touchscreen itself, particularly if an area has increased touch resolution or integrated imaging capabilities. A camera, such as camera 124, may also be used to capture other biometrics, such as a user's face or retina. Biometric input may be used by a user in lieu of or in addition to a manual login for convenience or security reasons.

As will be described in more detail below, an MFP controller and associated data storage may store information about a user. This may include information such as usernames, passwords, affiliations and permitted functions. The subject system further includes user biometric information that is coupled with selections for a user interface generated for that user. A user suitably enrolls one or more of their biometrics with the MFP system, and associates with it one or more parameters for interface generation. For example, a user may register one or more fingerprints and direct that they be associated with a left handed user interface setup on the touchscreen. When the user approaches an MFP, they can input their fingerprint, or other biometric, which is compared with archived fingerprint information. When a match is found, a left handed display may be applied for the device controls for that user. For convenience, the user credentials may similar be tied to a biometric, so the user can be logged in automatically, too.

In another example embodiment, the MFP detects handedness from a fingerprint chosen by a user. As will be detailed below, information within fingerprints themselves can make a determination as to whether a finger that is presented for the first time is a left handed print or a right handed print. With this capability, there is no need to preregister a fingerprint. In such an implementation, however, it may be advantageous to allow for a user to override a machine selection. For example, there may be situations wherein handedness is calculated incorrectly due to fingerprint handedness ambiguity. Other situations may include a user who, notwithstanding what their dominant hand is, chooses to use the other hand. One particular example may be when a user is injured. If a left handed user injures their left hand, they may wish to convert the screen to right handed use.

One further option to detect handedness is wherein the MFP biometric interface accommodates multiple fingers, or even an entire hand print. Relative sizes and positions of fingers, such an index finger and/or ring finger relative to a middle finger may provide a good indication of handedness without the necessity of fingerprint analysis or capture.

Biometric information and associated interface selections may exist on one device, such as MFP 104, such that a user might be afforded an opportunity to register on another device, such as MFP 108. Alternatively, archived biometric information, including associate user interface selections, may be propagated between MFPs, such as via network 130. Alternatively, this information may be stored on another network device, such as server 134.

In another example embodiment, an MFP may determine that the user's fingerprint is not reflected in the archived information. In such an instance, a default interface is implemented. For handedness accommodation, the default interface may be for a right handed user given the relative proportions of handedness for humans. Alternatively, when a fingerprint is not recognized, the MFP suitably prompts the user for registration of their biometric, which may be accompanied by other user data such as name, address, user ID, title, e-mail address, etc. The user is then suitably prompted for a preference of handedness. A display corresponding to the user's selection can be implemented for the current and future sessions for that user.

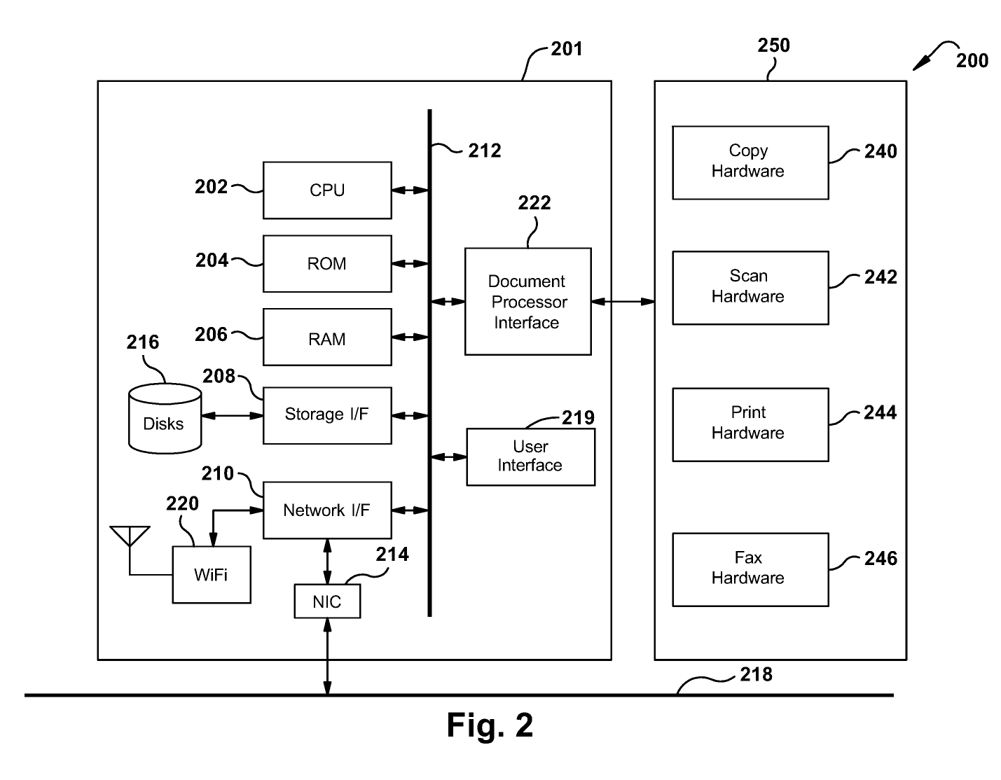

Turning now to FIG. 2, illustrated is an example embodiment of a document rendering system 200 suitably comprised within an MFP, such as with MFPs 104 and 108 of FIG. 1. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 218 or to a wireless data connection via wireless network interface 220. Example wireless connections include cellular, Wi-Fi, BLUETOOTH, NFC, wireless universal serial bus (wireless USB), satellite, and the like. Example wired interfaces include Ethernet, USB, IEEE 1394 (FireWire), LIGHTNING, telephone line, or the like.

Processor 202 can also be in data communication with any suitable user input/output (I/O) interface 219 which provides data communication with user peripherals, such as displays, keyboards, mice, track balls, touchscreens, or the like. Also in data communication with data bus 212 is a document processor interface 222 suitable for data communication with MFP functional units 250. In the illustrate example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

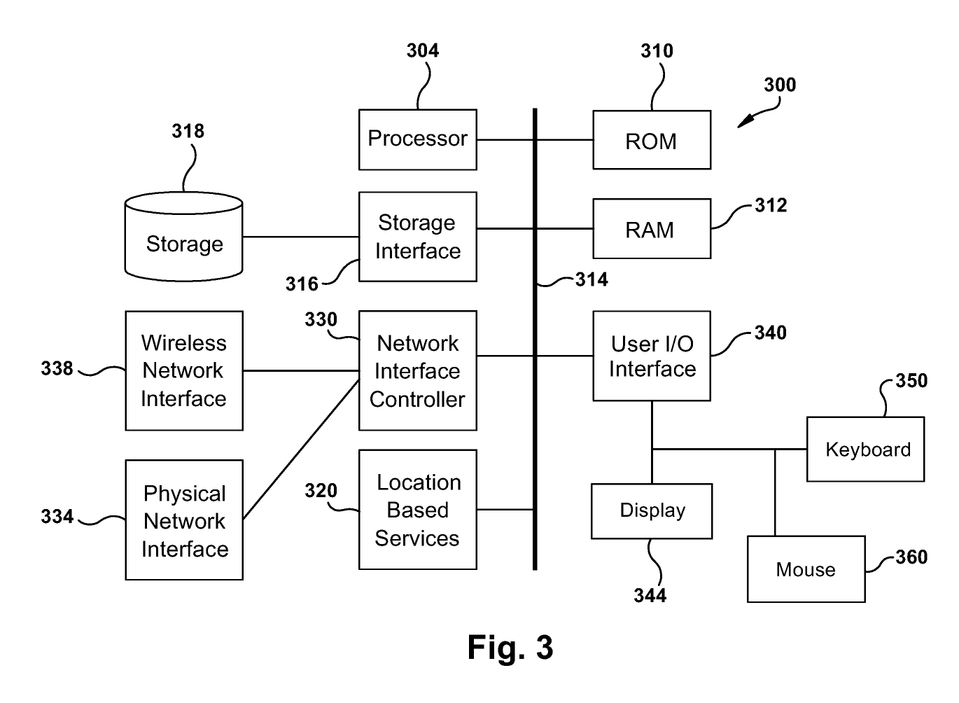

Turning now to FIG. 3, illustrated is an example embodiment of digital devices 300 such as server 134. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 316 for reading or writing to a data storage system 318, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable wired or physical network connection via physical network interface 334, or to any suitable wireless data connection via wireless network interface 338, such as one or more of the networks detailed above.

Processor 304 is also in data communication with a user input/output (I/O) interface 340 which provides data communication with user peripherals, such as display 344, as well as keyboard 350, mouse 360 or any other interface, such as track balls, touchscreens, or the like. It will be understood that functional units are suitably comprised of intelligent units, including any suitable hardware or software platform.

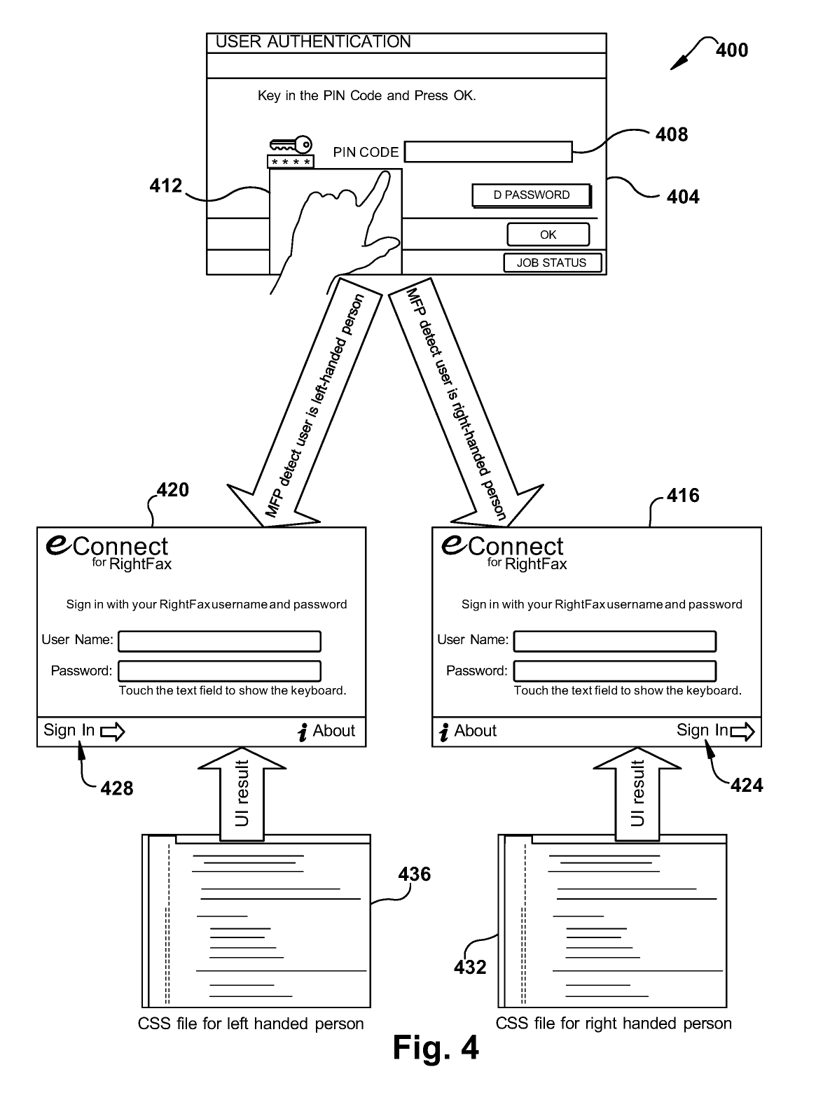

Referring next to FIG. 4, illustrated is an example embodiment of operation of a handedness adaptive user interface 400. In the example, an MFP device controller generates a login screen 404 for MFP operation. A conventional login, such as via a username, password, or personal information number (PIN) code may be entered at box 408, such as via a hard or soft keyboard (suitably generated on the display). A user inputs their biometric, such as a finger print or multiple finger prints, by touching a print reader 412 or a designated area of the login screen. The MFP may calculate handedness from the input biometric, or alternatively recognizes the stored handedness selection previously stored for the user. As noted above, a user may use their biometric to login to the device, negating a necessity to enter a username, password or PIN.

If the MFP determines that the user is right handed, an example right handed screen 416 is generated. If not, and example left hand screen 420 is generated. In the illustrated example of FIG. 4, screens 416 and 420 prompt for additional login information, but any suitable screen may follow initial screen 404, particularly if a user ID was already determined from the input biometric. In the example, it will be noted that a sign in selector 424, as a more frequent selection from the screen, is disposed at the right of screen 416 for right handed users, while sign in selector 428 is disposed at the left of screen 420 for left handed users. While any suitable encoding may be used to accomplish the example screen output of FIG. 4, one example is to have the screens generated, such as by cascading style sheets (CSS) 432 and 436.

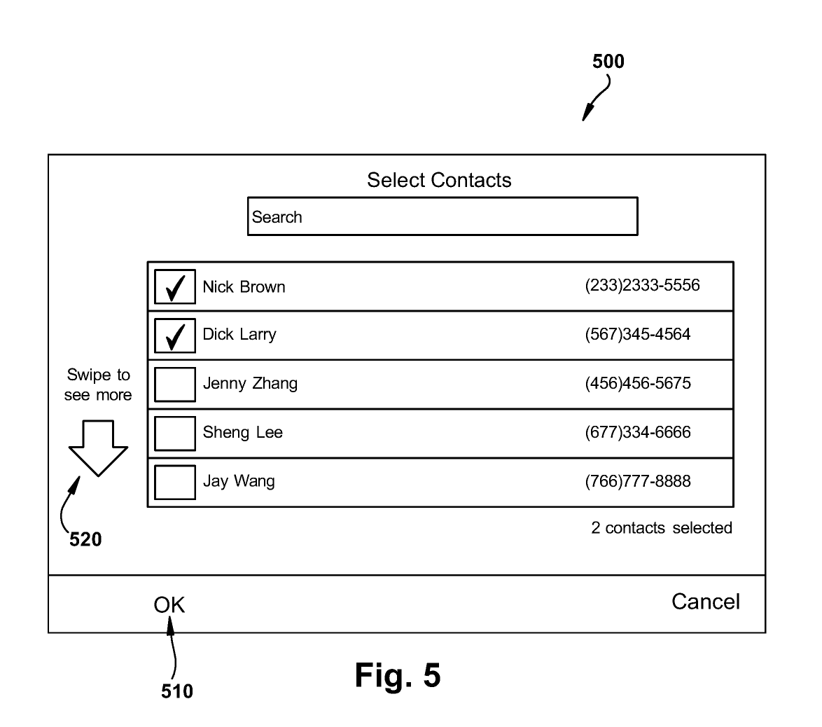

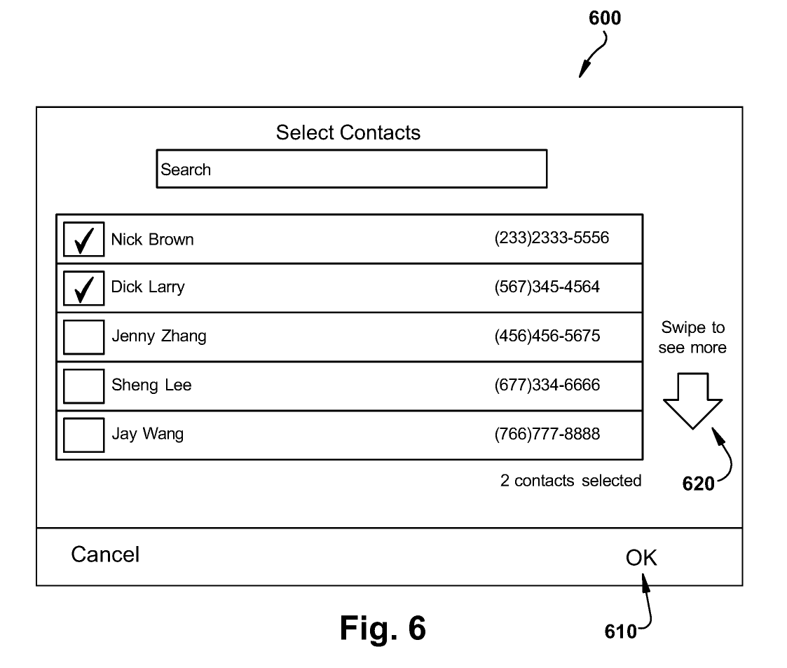

Further examples of handedness specific screens may be seen with screen 500 of FIG. 5, wherein an “OK” touchscreen selector 510 and a “swipe” touchscreen selector 520 are disposed on the left of left handed users and with FIG. 6, an equivalent screen 600 has an “OK” touchscreen selector 610 and “swipe” touchscreen selector 620 on the right side.

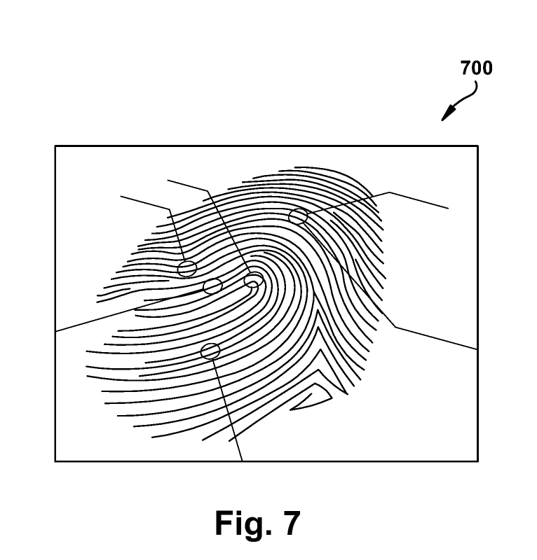

FIG. 7 is an example embodiment of a captured fingerprint where it is shown how different areas of characteristics of a fingerprint may be used to determine handedness or identify a user.

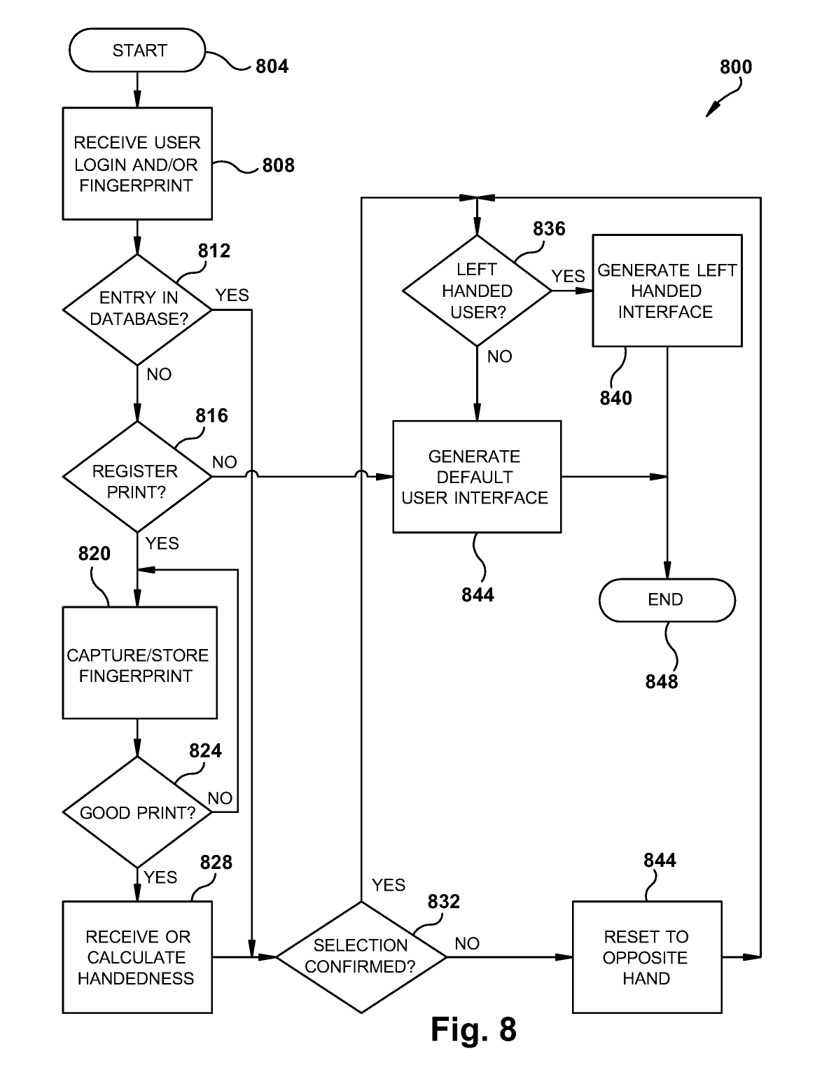

FIG. 8 illustrates a flowchart of an example embodiment of a method 800 for a handedness selection and detection system as suitably implemented on an MFP controller. The process commences at 804, and a user login and/or a biometric input, such as a fingerprint, is completed at 808. If the biometric is present in the database as determined at block 812, then handedness is confirmed at block 832, and processing continues as described below. If the biometric is not yet present in a database as determined at block 812, the user selects whether to register their print at block 816. If registration is chosen, a fingerprint is captured and stored at block 820. The process is suitably repeated if a determination that a good print capture has not been made at block 824. Once a good print is present, handedness of the associated user is calculated or received by user selection at block 828. If such selection is confirmed at block 832, a check is made for a handedness selection at block 836. Left handed users progress to block 840 wherein a left handed interface is generated and right handed users progress to block 844 for generation of a right handed interface. Since most users are right handed, right handed interfaces are generated at 844 if no choice to register an unregistered print is made at block 816.

If a handedness selection is not confirmed at block 832, the opposite handedness is selected at block 844, and the process proceeds to block 836 as described above. Once an appropriate interface is selected at 840 or 844, the selection process suitably ends at 848 and the user operates the MFP device with appropriate screens as will understood by one of ordinary skill in the art.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a user interface comprising,
a touch sensitive display, and
a biometric sensor configured to receive biometric input from an associated user;
a memory configured to store
handedness characteristic data, and
data corresponding to each of plurality of left handed and right handed control screen patterns for the display; and
a processor configured to
identify a user in accordance with received biometric input;
set handedness of the user in accordance with received biometric input and handedness characteristic data,
generate a selected control screen pattern from the left handed and right handed control screen patterns on the display in accordance with a set handedness of the user,
receive device control selection made from selection of touch screen areas corresponding to the control screen patterns by the identified user, and
control operation of a multifunction peripheral in accordance with received device control selections.

2. The system of claim 1 wherein the biometric sensor is comprised of a fingerprint scanner.

3. The system of claim 2 wherein the handedness characteristic data includes fingerprint data corresponding to a previously captured fingerprint from the user and a prior associated handedness selection.

4. The system of claim 2 wherein the touch sensitive display comprises the biometric sensor.

5. The system of claim 1 further comprising a network interface configured to receive biometric data from an associated data device.

6. The system of claim 1 wherein the biometric sensor is comprised of a digital camera.

7. The system of claim 6 wherein the digital camera is comprised of a retinal scanner.

8. A method comprising:
generating biometric data from interaction of an associated user with a biometric sensor;
retrieving handedness characteristic data from an associated memory;
determining, via a processor, handedness of the user in accordance with received biometric input and stored handedness characteristic data;
identifying the associated user in accordance with received biometric input;
retrieving data corresponding to a selected one of a plurality of left handed and right handed control screen patterns in accordance with a determined handedness of the user;
generating the selected control screen pattern on a touch sensitive display;
receiving device control selection from selection of touch sensitive display areas corresponding to the control screen pattern by the identified user; and
controlling operation of a multifunction peripheral in accordance with received device control selections.

9. The method of claim 8 further comprising generating the biometric data from a fingerprint scanner.

10. The method of claim 9 wherein the handedness characteristic data includes fingerprint data corresponding to a previously captured fingerprint from the user and a prior associated handedness selection.

11. The method of claim 8 further comprising generating the biometric data from a touch sensitive display comprising the biometric sensor.

12. The method of claim 8 further comprising receiving the handedness characteristic data from an associated data device via a data network.

13. The method of claim 8 further comprising generating the biometric data from a digital camera.

14. The method of claim 13 further comprising generating the biometric data from a retinal scan by the digital camera.

15. A multifunction peripheral comprising:
a controller including a processor and memory, the memory configured to
store data corresponding to each of a plurality of user interface configurations, and
store archived finger print data corresponding to fingerprints obtained from each of a plurality of persons;
a touch sensitive user interface including a display and a fingerprint scanner configured to capture a fingerprint from a device user; and
the processor configured to
identify one of the plurality of persons in accordance with a captured fingerprint and the archived finger print data;
generate selection data in accordance with the captured fingerprint and the archived finger print data, and
generate one of the plurality of user interface configurations on the display based at least in part on the generated selection data,
wherein the user interface is further configured to receive device control input from the device user via interaction with the generated one of the plurality of user interface configurations, and
wherein the controller is further configured to operate the multifunction peripheral in accordance with received device control input.

16. The multifunction peripheral of claim 15 wherein the processor is further configured to generate the selection data corresponding to a default user interface configuration when no archived fingerprint data corresponds to the device user.

17. The multifunction peripheral of claim 15 wherein the processor is further configured to generate user identifier data in accordance with a captured fingerprint.

18. The multifunction peripheral of claim 17 wherein the processor is further configured to generate a modified user interface configuration on the display in accordance with the user identifier data.

19. The multifunction peripheral of claim 15 further comprising a network interface configured to communicate the archived fingerprint data with an associated, networked data device.

20. The multifunction peripheral of claim 15
Wherein the processor is further configured to save data corresponding to the captured fingerprint in the archived finger print data when the selection data indicates that the archived finger print data has no entry corresponding to the captured fingerprint data,
wherein the processor is further configured to generate a prompt on the display to the user for selection of an interface handedness preference,
wherein the user interface is further configured to receive a handedness preference selection from the user responsive to the prompt, and
wherein the processor configured to save the handedness preference selection associatively with the captured fingerprint data.
